(19) United States
(12) Patent Application Publication
(10) Pub. No.: US 2010/0304184 A1
(43) Pub. Date: Dec. 2, 2010

(54) GALVANIZED WEATHERING STEEL

(75) Inventors: Michael Gall, Cordova, TN (US); Jackie Gordon Milam, Gadsden, AL (US)

Correspondence Address: Snyder, Clark, Lesch and Chung, LLP, 950 Herndon Ave,, Suite 365, Herdon, VA, 20170, US

(73) Assignee: THOMAS & BETTS INTERNATIONAL, INC., Wilmington, DE (US)

(21) Appl. No.: 12/787,475

(22) Filed: May 26, 2010

Related U.S. Application Data
(60) Provisional application No. 61/182,882, filed on Jun. 1, 2009.

(51) Int. Cl. B32B 15/18; B32B 15/01

(52) U.S. Cl. 428/659

(57) ABSTRACT

A steel structure may include a steel member that is fabricating using a weathering steel chemistry. The weathering steel chemistry may include silicon. The steel member may also include a zinc coating that covers at least some of the outer surface of the steel.

### RELATED APPLICATION

This application claims priority under 35 U.S.C. §119 based on U.S. Provisional Patent Application No. 61/182,882, filed Jun. 1, 2009, the disclosure of which is hereby incorporated herein by reference.

### BACKGROUND INFORMATION

Weathering steel chemistries based on the American Society for Testing Materials (ASTM) G101 specification are used to create steel members or structures that do not require painting or other corrosion prevention treatments. For example, weathering steel chemistries generate a stable rust-like patina on the outer surface of the steel. The rust-like patina acts as a protective layer for the steel. Conventional weathering steel chemistries allow a large variation in the amount of silicon in the steel.

Other mechanisms are also used to prevent corrosion or other environment-related damage to steel structures. For example, steel members are often galvanized in situations where corrosion, rust or other environment-related issues may adversely affect the steel.

### BRIEF DESCRIPTION OF THE DRAWINGS

FIG. 1 is a flow diagram of an exemplary process associated with manufacturing a steel member or structure consistent with aspects of the invention.

FIG. 2 is a table providing exemplary ranges for a steel chemistry used in accordance with aspects of the invention.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Embodiments described herein use a combination of a weathering steel chemistry and a galvanization process to produce a weather proof steel that has a uniform appearance. In an exemplary implementation, the weathering steel chemistry may include a narrow range of silicon, as compared to the ranges of silicon permitted in conventional weathering steel chemistries. Subsequent galvanization of the weathering steel results in a uniform appearance with respect to the finished steel product.

As discussed above, weathering steel chemistries are typically used to avoid painting steel or galvanizing steel that may be used in various steel structures that are exposed to environmental elements, such as rain, wind, salt, sun, etc. As also discussed above, conventional weathering steel chemistries allow a large range of silicon in the steel. For example, the American Society for Testing and Materials (ASTM) standard specification A871/A871M (referred to herein as ASTM A871) allows weathering steel chemistries to include silicon ranging from 0.30 to 0.65 percent by weight for Type I steel, 0.15 to 0.50 percent by weight for Type II steel, 0.15 to 0.40 percent by weight for Type III steel and 0.25 to 0.50 percent by weight for Type IV steel. Such broad ranges of silicon in weathering steel may result in inconsistent appearance of the weathering steel when a steel plate or other steel structure is later galvanized, as described in detail below.

In an exemplary implementation, a weathering steel chemistry may include a much narrower range of silicon than that permitted in conventional standards, such as ASTM A871. As one example, the amount of silicon provided in a weathering steel consistent with implementations described herein ranges from about 0.15 percent to about 0.30 percent by weight. By limiting the amount of silicon to this narrow range or less, the resulting weathering steel will have a much more uniform appearance after galvanization.

For example, the weathering steel produced in implementations described herein may be galvanized using a hot dip procedure. The hot dip procedure may galvanize the weathering steel and produce a steel member or structure that has a uniform appearance. Such a uniform appearance may result in a more aesthetically appealing finished product. That is, in situations in which the amount of silicon varies to a wider range, such as the ranges permitted in ASTM A871, the portions of the steel that have greater concentrations of silicon will result in darker areas, such as dark gray areas, after the weathering steel is galvanized.

For example, when the weathering steel is galvanized, the silicon in the weathering steel tends to absorb or bond with the zinc used in the galvanization process. As a result, the areas with higher concentrations of silicon will be dark gray in color. In contrast, portions of the steel having lower concentrations of silicon will be lighter in color, such as light gray in color. The resulting steel will then have a mottled, camouflage-like or inconsistent look with darker and lighter patches throughout. In addition, the amount of silicon may vary from sheet to sheet, even when the steel sheets are fabricated according to the same standard. This results in further inconsistencies in color or an otherwise non-uniform appearance of a finished steel product that may use steel members fabricated from different sheets of steel. Processing consistent with the invention generates a galvanized steel member/structure with a uniform appearance and improved weather resistant qualities, as described in detail below. For example, the galvanized steel may essentially have two layers of weather protection. That is, the galvanized steel may form a rust-like layer or patina based on the weathering chemistry and a galvanized outer layer formed over the weathering steel. Additionally, the amount of zinc on this galvanized weathering steel is typically higher than a non-weathering steel, thereby increasing its resistance to corrosion. The galvanized weathering steel also exhibits a uniform appearance while avoiding rusting or other negative effects from exposure to the environment, as described in detail below.

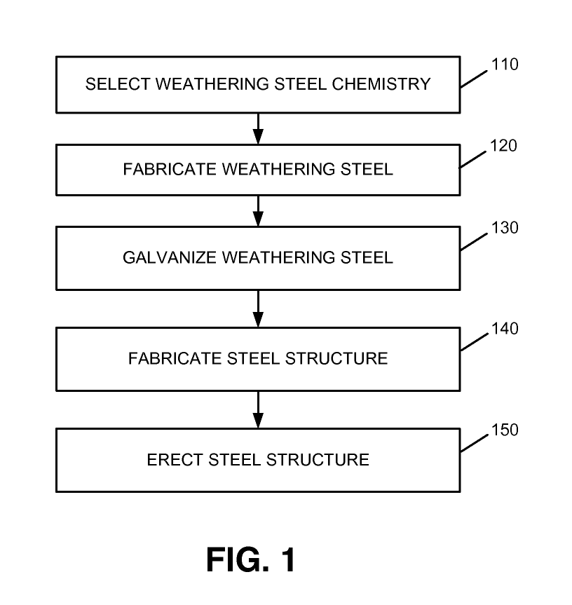

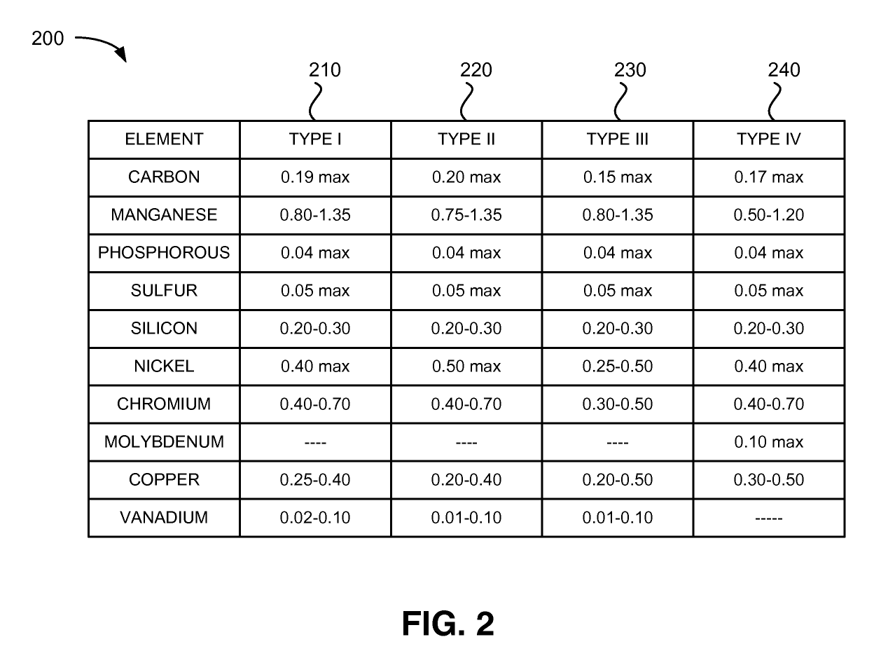

FIG. 1 is a flow diagram illustrating exemplary processing associated with fabricating steel that may be used in environments in which the steel is exposed to the weather or other external elements. Processing may begin by selecting a weathering steel chemistry (act 110). For example, as described above, a weathering steel chemistry consistent with implementations described herein may be chosen to include a narrow range of silicon, as compared to conventional silicon ranges used in standard weathering steel. In an exemplary implementation, a weathering steel chemistry may be selected from table 200 illustrated in FIG. 2.

Table 200 includes weathering steel chemistries for Type I, Type II, Type III and Type IV steel, illustrated in columns 210, 220, 230 and 240, respectively. Referring to table 200 at column 210, the range of silicon for Type I steel may range from 0.20 to 0.30 percent by weight, The other ranges of the various elements for Type I steel may correspond to the ranges provided in ASTM A871. For example, the percentage by weight of carbon may be a maximum of 0.19 percent, the percentage by weight of manganese may range from 0.80 to 1.35, the percentage by weight of phosphorous may be a maximum of 0.04, the percentage by weight of sulfur may be a maximum of 0.05, the percentage by weight of nickel may be a maximum of 0.40, the percentage by weight of chromium may range from 0.40 to 0.70, the percentage by weight of copper may range from 0.25 to 0.40 and the percentage by weight of vanadium may range from 0.02 to 0.20. The remaining portion of the steel may be iron, with insignificant portions being impurities. For table 200, tolerances associated with each of the ranges may be in accordance with ASTM standard A6. In the steel chemistry illustrated in column 210, by closely controlling the steel fabrication process such that silicon is provided in a narrow range, the steel fabricated using this weathering chemistry will suffer from fewer inconsistencies with respect to the amount of silicon throughout the steel. That is, the silicon concentration will be more homogeneous or even throughout the steel. As a result, when the weathering steel is subsequently galvanized, a more uniform appearance of the steel is obtained, as described in more detail below.

Referring back to FIG. 2, column 220 illustrates a weathering steel chemistry for a Type II steel, column 230 illustrates a weathering steel chemistry for a Type III steel and column 240 illustrates a weathering steel chemistry for a Type IV steel. In each of these types of steel, the amount of silicon ranges from 0.20 to 0.30 percent by weight. The other ranges of the various element in columns 220, 230 and 240 may correspond to the ranges provided in ASTM A871. Similar to the discussion above with respect to Type I steel illustrated in column 210, by providing a narrow range of silicon (e.g., from 0.20 to 0.30 percent by weight), the steel fabricated using the steel chemistries illustrated in columns 220, 230 and 240 will suffer from less inconsistencies with respect to the amount of silicon throughout the steel. As a result, the weathering steel fabricated using any of these steel chemistries and later galvanized will result in a steel member/structure having a uniform look.

Referring back to FIG. 1, after a steel chemistry is selected (e.g., any one of the steel chemistries illustrated in table 200), the steel may be fabricated (act 120). For example, assume that a type II weathering steel chemistry is selected for a particular steel structure, such as a steel sheet, that is to be fabricated. In this case, the steel sheet may be fabricated in accordance with the weathering chemistry illustrated in column 220. As discussed above, the amount of silicon in such a steel chemistry is limited to a range of 0.20 to 0.30 percent by weight. In this instance, the silicon is much more likely to have a more uniform or even distribution of silicon throughout the steel sheet, as compared to situations in which the range of silicon is much greater, such as a range of 0.15 to 0.50 percent for Type II steel according to ASTM A871. In addition, by closely controlling the amount of silicon to this narrow range, inconsistencies between different sheets of steel are significantly reduced. This is particularly beneficial in large steel structures that include steel members made from different sheets of steel.

After the steel is fabricated, the steel may be galvanized (act 130). In some instances, the same fabricator or fabrication facility used to fabricate the weathering steel may be used to galvanize the steel. In other instances, the fabricated steel may be shipped to another location for galvanization. In either case, the steel may be galvanized using any suitable galvanization procedure.

For example, in one implementation, the steel may be fabricated using a hot dip galvanization process. In such implementations, the weathering steel may be passed through a molten bath of zinc to provide a relatively thin coating of zinc on the outer surface of weathering steel. When the zinc is exposed to the atmosphere, the zinc reacts with oxygen to form zinc oxide. The zinc oxide may further react with carbon dioxide to form a zinc carbonate. The zinc carbonate formed on the outer surface of the weathering steel may be gray in color. In alternative implementations, other types of galvanization processes may be used. In each case, the weathering steel may be galvanized to further protect the steel from various corrosive effects. In addition, increasing the zinc content of the weathering steel via the galvanization increases the weathering steel's corrosion resistance. That is, the amount of zinc formed on the outer surface of the weathering steel may be increased based on the particular use for the weathering steel to provide adequate protection from the environment.

The galvanized steel may then be used to fabricate a steel structure (act 140). For example, in one implementation, the galvanized weathering steel may be used to fabricate electrical utility structures, such as high voltage electrical transmission towers, lattice towers, wind power structures (e.g., wind turbines) or substation structures. Alternatively, the galvanized weathering steel may be used to fabricate communications-related structures, such as cellular or wireless transmission towers used in communication systems/networks. In still other implementations, the galvanized weathering steel may be used in various buildings or other outdoor structures, such as lighting structures/poles, bridges, roadside guard rails, billboard structures/supports, etc. In each case, the steel structure may be erected (act 150). In addition, in each case, the galvanized weathering steel may have a uniform appearance that is aesthetically appealing.

In addition, the galvanized weathering steel may provide enhanced weather proofing as compared to a typical galvanized steel. For example, in situations where the galvanization process does not take in all areas of the steel member, portions of the galvanized coating falls or flakes off after the steel member is being used, or the galvanized finish is damaged and not repaired, etc., a rust-like weathering patina will develop on the outer surface of the steel based on the underlying weathering steel chemistry. The weathering patina or rust-like coating will then protect the steel from corrosive elements/effects. In essence, using a galvanized weathering steel provides an added layer of protection for the steel member.

The foregoing description of exemplary implementations provides illustration and description, but is not intended to be exhaustive or to limit the embodiments described herein to the precise form disclosed. Modifications and variations are possible in light of the above teachings or may be acquired from practice of the embodiments.

For example, various features have been mainly described above with respect to FIG. 2 as using a weathering steel chemistry that includes a relatively narrow range of silicon (e.g., 0.20 to 0.30 percent by weight) throughout the steel. In other instances, other ranges of silicon may be used. For example, an amount of silicon ranging from 0.10 to 0.20 percent by weight, 0.30 to 0.40 percent by weight, 0.40 to 0.50 percent by weight, etc., may be used. In some implementations, the percentage range of silicon may be selected based on a desired color for the finished product. For example, if a darker color finished product is desired, a higher concentration of silicon (e.g., 0.40 to 0.50 percent) may be chosen. However, in each implementation, the range of silicon may be controlled to provide a relatively narrow variation/range, such as less than a 0.15 percent by weight range (e.g., a 0.10 percent range). This results in a weathering steel in which the concentration or amount of silicon is relatively even or consistent throughout the fabricated steel structure.

In addition, in other implementations, the amount of silicon may be more closely controlled to produce an even more uniform distribution of silicon throughout. For example, in some implementations, the silicon may be controlled to a more narrow variation/range, such as less than 0.05 percent by weight variation/range. As examples, in some implementations, an amount of silicon ranging from 0.20 to 0.25 percent by weight, 0.25 to 0.30 percent by weight, 0.30 to 0.32 percent by weight, etc., may be used to produce a weathering steel with a very even distribution/concentration of silicon throughout the steel sheet or other fabricated steel product. The galvanized weathering steel may then produce an even more uniform appearance.

Further, aspects have been described above with respect to fabricating various steel products, such as steel sheets, that may be used to manufacture other products/structures. It should be understood that processing consistent with aspects described above may be used to fabricate any type of steel products, such as steel bars, steel beams or any other type of steel products.

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above mentioned description is to be considered exemplary, rather than limiting, and the true scope of the invention is that defined in the following claims.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A structure, comprising:
at least one steel member, the at least one steel member including:
steel fabricated using a weathering steel chemistry, the weathering steel chemistry including silicon ranging from 0.20 percent to 0.30 percent by weight, and
a coating comprising zinc that covers at least some of the outer surface of the steel.

2. The structure of claim 1, wherein the weathering steel chemistry further comprises carbon, manganese, phosphorous, sulfur, nickel, chromium, copper and vanadium.

3. The structure of claim 2, wherein the amounts of carbon, manganese, phosphorous, sulfur, nickel, chromium, copper and vanadium in the weathering steel are in accordance with the American Society for Testing and Materials (ASTM) specification A871.

4. The structure of claim 1, wherein the amount of silicon in the steel is relatively consistent or uniform throughout the at least one steel member and a color of the at least one steel member is relatively uniform or consistent throughout the at least one steel member.

5. The structure of claim 1, wherein the at least one steel member comprises a plurality of steel members and the structure comprises an electrical transmission tower.

6. The structure of claim 1, wherein the at least one steel member comprises a plurality of steel members and the structure comprises a cellular transmission tower or wind turbine.

7. The structure of claim 1, wherein the at least one steel member comprises a plurality of steel members and the structure comprises a lighting structure, a billboard support, a guard rail, a building or a bridge.

8. A method, comprising:
fabricating a steel member using a weathering chemistry, the weathering chemistry including silicon ranging from 0.15 percent to 0.30 percent by weight; and
galvanizing the steel member.

9. The method of claim 8, wherein the weathering steel chemistry further includes carbon, manganese, phosphorous, sulfur, nickel, chromium, copper and vanadium.

10. The method of claim 8, wherein the amounts of carbon, manganese, phosphorous, sulfur, nickel, chromium, copper and vanadium in the weathering steel are in accordance with the American Society for Testing and Materials (ASTM) specification A871 or ASTM specification G101.

11. The method of claim 8, wherein the fabricating a steel member comprises fabricating a steel sheet such that the amount of silicon in the steel sheet is relatively homogeneous throughout the steel sheet.

12. The method of claim 11, wherein the at least one steel member comprises a plurality of steel members forming at least a portion of an electrical transmission tower.

13. The method of claim 8, wherein the at least one steel member comprises a plurality of steel members forming a least a portion of a cellular transmission tower or wind turbine.

14. The method of claim 8, wherein the at least one steel member comprises a plurality of steel members forming a least a portion of a building, a bridge, a lighting structure, a billboard support or a guard rail.

15. The method of claim 8, further comprising:
erecting a structure including the steel member.

16. The method of claim 8, further comprising:
selecting a range of silicon percentage by weight for the steel member based on at least one of a desired color of the steel member or a desired uniformity in color of the steel member.

17. A steel structure, comprising:
a steel member including:
steel fabricated using a weathering steel chemistry, the weathering steel chemistry including silicon, and
a coating comprising zinc that covers at least some of the outer surface of the steel.

18. The steel structure of claim 17, wherein the amount of silicon in the steel is uniform throughout the steel member.

19. The steel structure of claim 18, wherein the amount of silicon in the steel varies by less than 0.10 percent by weight throughout the steel member.

20. The steel structure of claim 18, wherein the amount of silicon ranges from 0.20 to 0.30 percent by weight.
